(19) United States
(12) Patent Application Publication
(10) Pub. No.: US 2009/0139913 A1
(43) Pub. Date: Jun. 4, 2009

(54) High Capacity Sweepside Mail Cart and Method of Use Thereof

(75) Inventors: James M. Pippin, Keller, TX (US); Floyd W. Worth, Richardson, TX (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS ENERGY & AUTOMATION, INC., Arlington, TX (US)

(21) Appl. No.: 12/328,049

(22) Filed: Dec. 4, 2008

Related U.S. Application Data
(60) Provisional application No. 60/992,181, filed on Dec. 4, 2007.

(51) Int. Cl. B07C 3/08; B62B 3/00; A47F 7/00

(52) U.S. Cl. 209/584; 280/47.11; 211/153

(57) ABSTRACT

A postal cart according to the invention includes a base on wheels and a support frame mounted on the base. An upper shelf and a lower shelf are mounted at the top and bottom of the frame and accessible from a front side of the cart. A series of rectangular compartments are accessible from the front side of the cart, each compartment configured for storage of one postal tray filled with mail, but insufficiently wide to store more than one such postal tray side by side in the same compartment. A number of pull out sliding shelves are mounted along the bottom of no more than about half of the compartments, the remaining compartments being free of the sliding shelves. The compartments are configured to fit one tray in each. The vertical density of the compartments is greater than would be possible if a sliding shelf were disposed in all of the compartments.

This application claims priority of U.S. provisional application No. 60/992,181 filed Dec. 4, 2007.

### FIELD OF THE INVENTION

The invention relates to a mail transport cart for use in a postal sorting facility as currently operated by the U.S. Postal Service (USPS).

### BACKGROUND OF THE INVENTION

The USPS carries out mail sorting operations using automated sorting machines which include DBCS and MLOCR machines. These sorters include a feeder which feeds letters one at a time into a pinch belt conveyor system which transports each mail piece past a scanner or image lift camera that scans one or both faces of the mail piece for destination indicia, i.e. a printed bar code or address which can be read using optical character recognition (OCR). The mail is sorted automatically into pockets of a stacker, which are manually swept by postal workers, the contents being put into trays. The trays are then put onto carts for the next stage of postal processing. The cart currently used for this purpose, known as the 1226, is described further below.

Another commonly used cart in postal facilities for transport of mail in trays is the APC (all purpose container) comprises a pair of barred cages open at the front in which mail trays are stacked, often in an irregular manner. The bottom cage is mounted on wheels. It is approximately six feet high, two feet wide, and three and a half feet long. It weighs over 200 pounds empty and may carry over 800 pounds of mail. The APC has an upper and lower compartment. There is at least one reported case of an injury involving an APC, see, Ronald D. PRIOR, v. UNITED STATES POSTAL SERVICE, 985 F.2d 440. That accidents can happen is not surprising considering the weight of the unit, its design and the amount of mail it can contain.

The size of the APC also limits or prevents its use sweepside, that is, next to a stacker where human workers are sweeping mail. For this purpose a smaller cart called the 1226 is used. The 1226 is likewise a steel frame, six level cart. The top and bottom shelves are open. The four intermediate levels are each provided with a row of pull out shelves or slides. These take up considerable space, so the number of levels is limited to six total, with six shelves per row, limiting the middle levels of the cart to 24 trays of the plasticEMM type.

While a great variety of carts have been the subject of patents, none are well adapted to take the place of the 1226 in postal sweeping operations and for later transportation and unloading. The present invention addresses this deficiency.

### SUMMARY OF THE INVENTION

A postal cart according to the invention comprises a base and suitable means mounted on the base for rollingly supporting the base for horizontal movement; (wheels casters or the like). A support frame is mounted on the base extending upwardly therefrom. An upper shelf and a lower shelf are mounted at the top and bottom of the frame and accessible from a front side of the cart. A series of rectangular compartments are likewise accessible from the front side of the cart, each compartment having a rectangular shape configured for storage of one postal tray filled with mail, but insufficiently wide to store more than one such postal tray side by side in the same compartment, the compartments arranged in rows and columns. A number of pull out sliding shelves are mounted along the bottom of no more than about half of the compartments, the remaining compartments being free of the sliding shelves. The compartments are configured to fit one tray in each, and the vertical density of the compartments is greater than would be possible if a sliding shelf were disposed in all of the compartments. “Vertical density” in the context of the present invention means the number of shelves per unit of height, and is greater in the present invention than in the prior art 1226 cart.

The invention further provides a method of sorting mail using an automated postal sorting machine than includes a mail feeder, a pinch belt conveyor that receives singulated mail pieces from the feeder, a scanner that scans address information from the mail pieces transported by the pinch belt conveyor, and a stacker. Such a method includes steps of:

(a) deploying a row of the carts described above sweepside of a stacker in positions that facilitate manual sweeping of mail and placement of mail onto the carts;

(b) extending one of the extendable shelves from a first compartment;

(c) placing a first empty postal tray on the extended shelf;

(d) sweeping mail from a stacker pocket into the tray on the extended shelf;

(e) when the first tray is full, moving the first tray to a second compartment lacking an extendable shelf, which second compartment is associated with the first compartment as containing mail swept from the same stacker pocket;

(f) placing a second empty tray on the extended shelf;

(g) sweeping mail from the stacker pocket into the second tray on the extended shelf; and

(h) pushing in the extended shelf in order to store the second tray containing swept mail in the first compartment.

Such steps are repeated for additional stacker pockets until the cart is full or the sorting pass is completed. Thereafter the cart may be moved away for transport to a delivery unit or for unloading at a feeder, if the mail is to be sorted in a second pass.

A feeder for purposes of the present invention has its art-recognized meaning, namely a mechanism which takes mail pieces from a stack one at a time and feeds them into a pinch belt conveyor system which is part of the sorting machine. Likewise a stacker for purposes of the present invention has its art-recognized meaning, namely a section of a sorting machine that receives a stream of singulated mail pieces moving along a pinch belt conveyor system and diverts such mail pieces to pockets according to sort scheme criteria. It is to be understood that terms used in the present invention should be given their meanings recognized in the postal sorting art, if applicable, not more general definitions found in dictionaries.

In a two pass sort of a kind known in the art, the mail is re-fed into the sorting machine after the first pass for sorting in the second pass. The present invention facilitates keeping groups of mail from sorting pockets together for purposes of later sorting or delivery. These and other aspects of the invention are discussed in the detailed description that follows.

### BRIEF DESCRIPTION OF THE DRAWINGS

In the accompanying drawings, where like numerals denote like elements and letters denote multiples of a component:

FIG. 1 is a front perspective of a cart according to the present invention;

FIG. 2 is a schematic diagram of cart layout prior to a sorting pass;

FIG. 3 is a schematic diagram of cart layout after a sorting pass;

FIG. 4 is a size comparison between a DBCS stacker, the cart of the invention and a 1226 cart; and

FIG. 5 is a diagram of preferred dimensions of a cart according to the invention.

### DETAILED DESCRIPTION

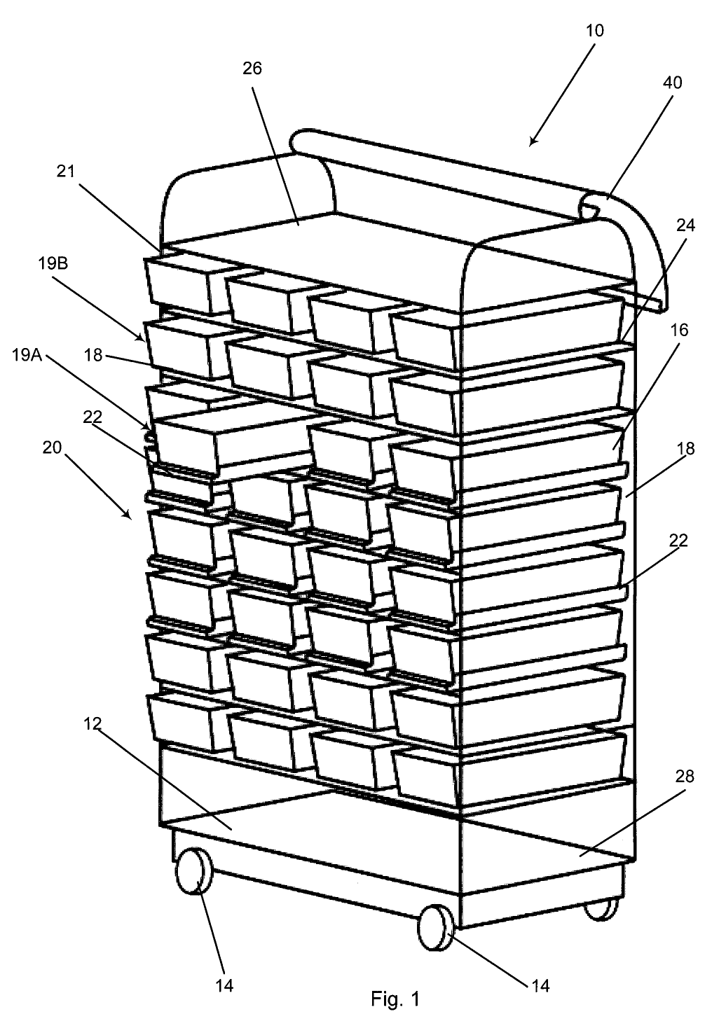

Referring to FIG. 1, a cart 10 according to the present invention comprises a flat, square or rectangular base 12 having pivoting wheels 14 at its corners. Wheels 14 are designed for supporting hundreds of pounds of mail. An array of standard rectangular postal trays 16 are positioned in a series of compartments 18 that are provided in at least three columns and in from four to as many as eight rows, forming a mid-section 20 of cart 10. Some of compartments 18 are provided with horizontal pull-out shelves or drawers 22. Pull-out shelves 22 can be provided with handles or handhold recesses to allow a postal worker to grasp and pull a shelf 22. Mid section 20 can be formed by four vertical bars at each corner of cart 10 spanned by the evenly spaced horizontal plates 24. Pull-out shelves 22 are each mounted by standard drawer hardware on certain of compartments 18. As explained hereafter, for use during sweeping, it is advantageous to provide drawers or pull-outs 22 only at certain compartments 18 to facilitate use without using more pull-out shelves than are needed, which pull-out shelves would otherwise add weight and size to the cart.

A top shelf 26 is available for tray storage above mid-section 20, and a lower shelf 28 (which could be formed by base 12) provides a lower compartment below mid-section 20. The lower compartment preferably has about twice the height (vertical dimension) of the compartments 18 in mid section 20. Compartments 18 may be divided from one another by spaced partitions which are part of the frame 21, but it is generally sufficient to configure them precisely to the dimensions of the postal trays 16 so that the trays 16 fit side by side in a row as shown. When a pullout 22 is present, the tray 16 fits exactly on it.

The number of compartments provided with pull out shelves is no more than half the total number of compartments, and as shown it is preferred that all the compartments 18 in a row 19 either have (19A) or do not have (19B) pull out shelves. It is not essential to alternate rows 19A and 19B, but a dual tier arrangement wherein such rows 19A 19B are easily paired by a human worker is preferred.

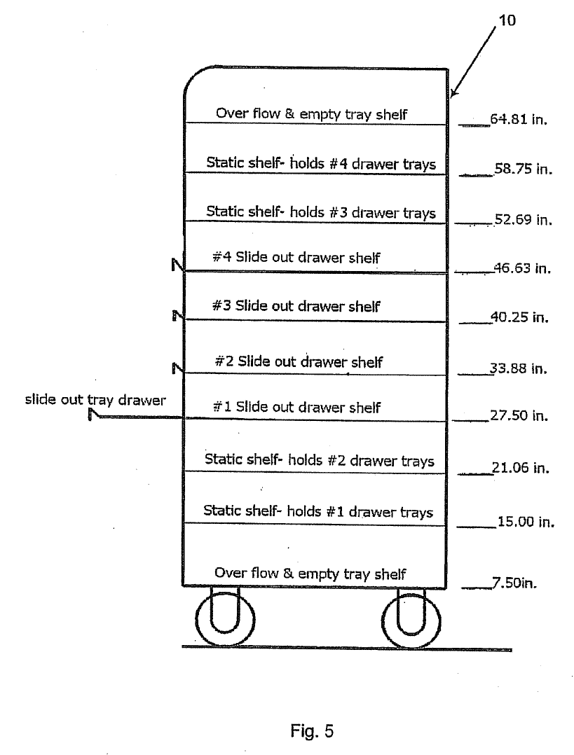

In the embodiment shown in FIGS. 1 and 5, four rows 19A of active shelves have reach and drawer extension dimensions within the envelope of the 1226 and a footprint within that needed in a standard GPMC (General Processing Mail Center). As part of such a standard, the maximum height reached by a human worker should not exceed 71 inches and the minimum height reached should not be less than 7.5 inches. FIGS. 1 and 5 show an inside-outside arrangement wherein the pull out shelves 22 are grouped together (four in a row) with the four rows 19B lacking pullout shelves 22 arrangement two above and two below. This has ergonomic advantages in that the pullout shelves can be used at convenient heights for human workers sweeping pockets of a sorting machine stacker. Compartments 18 with static shelves in rows 19B are provided at higher and lower levels of the cart mainly for storing full trays, and are accessed less often than the levels with pull-out shelves 22.

Over-under/dual tier static shelves sized for postal trays visually associate with adjacent or nearby pull-out shelves to facilitate tray sequencing. For example, the compartment 18 in row 19A can be visually associated with the compartment 18 in the same column in a row 19B either two levels above or below. The compartments 18 of the dual tiers can be labeled or color coded so that the operator can see which compartments form a dual tier pair. During pocket sweeping, as the first tray becomes full with mail, it is withdrawn and placed on the assigned static shelf compartment 18 to provide twice the tray buffer of a standard 1226. Empty and overflow trays can be stored in the lower compartment or the top most shelf 26.

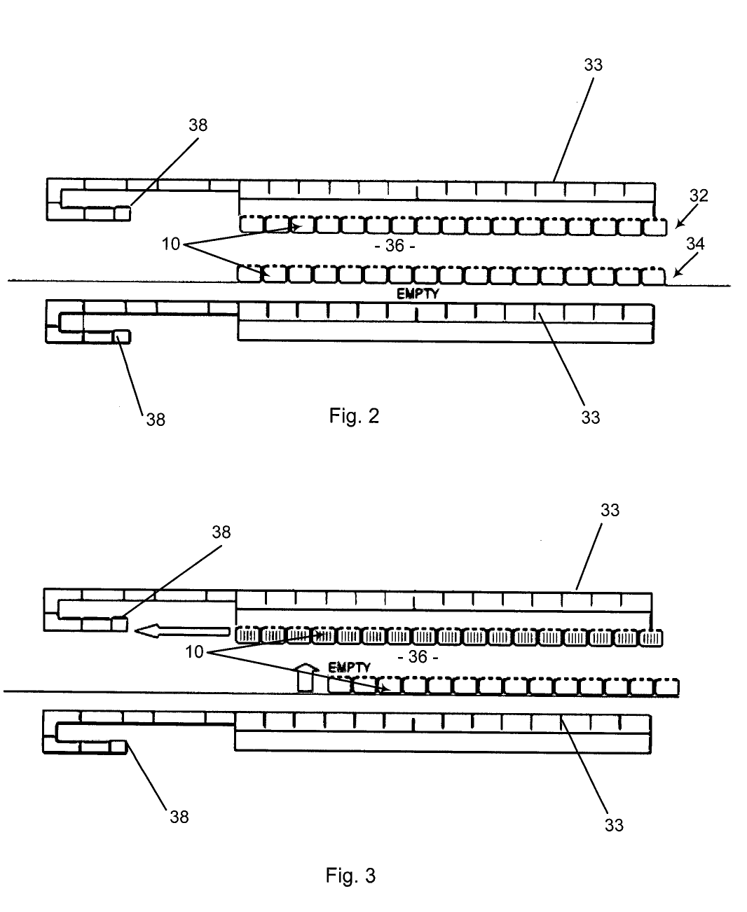

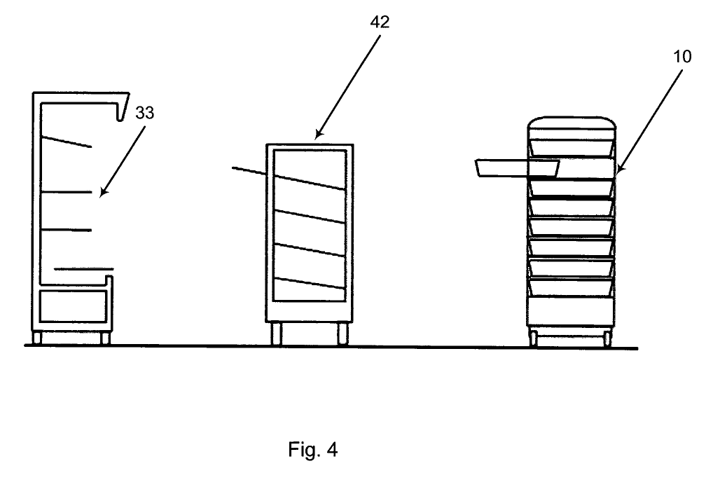

FIGS. 2-3 show the use of carts 10 at a GPMC. At the start of the day, carts 10 loaded with empty trays 16 are arranged in a first row 32 along the sweepside of the DBCS stackers 33. A second row 34 of carts 10 are arranged along a walk aisle 36 located immediately behind the first row 32. During the first pass of a two pass sort, mail pieces sorted to pockets are removed and swept to trays 16. In a preferred embodiment, at least four levels of sliding, drawer like shelves 22 are pulled out to extend from the front of the cart 10 to help the sweeper transfer handfuls of mail from a stacker pocket to an associated tray 16 which rests on the pullout shelf 22. Additional empty trays are stored in stacks on the bottom and/or top areas 26, 28 of the cart.

When the first tray 16 is filled, it is placed in the associated compartment 18 of a row 19B having a static shelf to keep the first and second trays 16 used for sweeping that pocket associated. The second tray remains in the compartment 18 of row 19A. It can be stored there on the pullout shelf 22 by pushing the shelf 22 in. If a pocket requires more than two trays (overflow), then overflow trays are staged on the bottom shelf 28 in the lower compartment.

At the end of the first pass, filled carts 10 are rolled away and staged by the feeder 38 to begin the second pass. The queue of empty carts 10 in the second row 34 are moved by stackers 33 forming a new first row 32. As carts 10 are emptied by the feeder operator, they are rolled to the empties queue (row 34 along the walk aisle 36). Second pass mail is swept from the pockets into carts 10 in first row 32.

At the end of the second pass, carts 10 can be rolled directly to a dock area, loaded onto trucks and shipped to the postal Delivery Unit (DU). After unloading at the DU, the carts 10 are returned by truck or other transport to the processing center for further use. Since carts 10 taken outdoors may be briefly exposed to the elements, a cover 40 is mounted at the top of frame 21 to be pulled over the otherwise open top shelf 26. Cover 40 can be a loose hood of plastic or canvas, or a lid pivotally or slidingly mounted along the back of frame 21 at the top. If a loose cover is provided, it can take the form of a rectangular sack that can be pulled down over the entire length of cart 10 above wheels 14. Eyelets provided along the edges of four downwardly depending flaps can be used to secure the resulting hood at the four corners of cart 10 with rope or the like.

To perform all of the foregoing functions as successfully as possible in a postal facility, the cart 10 must be configured to fit within the available space. FIG. 4 compares the dimensions of a preferred cart 10 of the invention with a DBCS stacker 33 and a prior art 1226 cart 42. The dimensions shown for cart 10 reflect a careful balancing of ergonomic considerations which workers in the art have heretofore ignored. The 1226 cart is well within the preferred height and width limits, but is too long to be easily maneuvered in a postal facility. Its vertical cell density is poor because it has more pull out shelves than are needed. Cart 10 of the invention is taller but less long than the 1226. The reduced length of cart 10 makes it considerably more maneuverable than the 1226. Its greater height can be considered an ergonomic disadvantage, but top shelf 26 is most often used for storing empty trays which are not heavy. Top shelf 26 would by preference only be used for holding full trays of mail when no other spaces are available. The cart of the invention likewise has better dimensions for transport by truck, i.e. more carts 10 can fit into a rectangular truck box. Accordingly the present invention provides improved performance and additional functions as compared to existing carts used in postal facilities.

Although several embodiments of the present invention have been described in the foregoing detailed description and illustrated in the accompanying drawings, it will be understood by those skilled in the art that the invention is not limited to the embodiments disclosed but is capable of numerous rearrangements, substitutions and modifications without departing from the spirit of the invention. Such modifications are within the scope of the invention as expressed in the appended claims.

1. A postal cart, comprising:
a base;
means mounted on the base for rollingly supporting the base for horizontal movement;
a support frame mounted on the base extending upwardly therefrom;
an upper shelf, and a lower shelf mounted at the top and bottom of the frame and accessible from a front side of the cart;
a series of rectangular compartments accessible from the front side of the cart, each compartment having a rectangular shape configured for storage of one postal tray filled with mail, but insufficiently wide to store more than one such postal tray side by side in the same compartment, the compartments arranged in rows and columns; and
a number of pull out sliding shelves mounted along the bottom of no more than half of the compartments, the remaining compartments being free of the sliding shelves, wherein the rows of compartments are configured to fit one tray in each, and the vertical density of the compartments is greater than would be possible if a sliding shelf were disposed in all of the compartments.

2. The cart of claim 1, wherein the compartments with pull-out shelves are arranged in first horizontal rows, and the compartments without pull-out shelves are arranged in second horizontal rows.

3. The cart of claim 3, wherein second rows are positioned both above and below the first rows.

4. The cart of claim 3, wherein the first rows are positioned adjacent one another, and the second rows are positioned adjacent one another in two groups above and below the first rows.

5. The cart of claim 4, wherein the first and second rows each have an equal number of compartments, and the number of compartments with and without pull-out shelves are equal.

6. The cart of claim 5, wherein there are at least six rows and at least four columns of compartments.

7. The cart of claim 6, wherein there are 32 compartments, four per row and eight per column.

8. A method of sorting mail using an automated postal sorting machine than includes a mail feeder, a pinch belt conveyor that receives singulated mail pieces from the feeder, a scanner that scans address information from the mail pieces transported by the pinch belt conveyor, and a stacker, comprising:
(a) deploying a row of carts sweepside of a stacker in positions that facilitate manual sweeping of mail and placement of mail onto the carts, which carts each comprise a base, means mounted on the base for rollingly supporting the base for horizontal movement; a support frame mounted on the base extending upwardly therefrom, an upper shelf and a lower shelf mounted at the top and bottom of the frame and accessible from a front side of the cart, a series of rectangular compartments accessible from the front side of the cart, each compartment having a rectangular shape configured for storage of one postal tray filled with mail, but insufficiently wide to store more than one such postal tray side by side in the same compartment, the compartments arranged in rows and columns, a number of pull out sliding shelves mounted along the bottom of no more than half of the compartments, the remaining compartments being free of the sliding shelves, wherein the rows of compartments are configured to fit one tray in each, and the vertical density of the compartments is greater than would be possible if a sliding shelf were disposed in all of the compartments;
(b) extending one of the extendable shelves from a first compartment;
(c) placing a first empty postal tray on the extended shelf;
(d) sweeping mail from a stacker pocket into the tray on the extended shelf;
(e) when the first tray is full, moving the first tray to a second compartment lacking an extendable shelf, which second compartment is associated with the first compartment as containing mail swept from the same stacker pocket;
(f) placing a second empty tray on the extended shelf;
(g) sweeping mail from the stacker pocket into the second tray on the extended shelf; and
(h) pushing in the extended shelf in order to store the second tray containing swept mail in the first compartment.

9. The method claim 8, further comprising repeating steps (b)-(h) for additional pockets of the stacker until the cart compartments are full or sorting is completed.

10. The method of claim 9, further comprising, after the cart compartments are full or a sorting pass is completed, transporting the cart away from its sweepside position.

11. The method claim 10, wherein following a second pass of a two pass sort, loading the cart into a delivery motor vehicle and transporting the loaded cart to a postal delivery unit.
